(19) United States
(12) Patent Application Publication
(10) Pub. No.: US 2007/0297302 A1
(43) Pub. Date: Dec. 27, 2007

(54) APPARATUS AND METHOD FOR SERVO BALANCE CALIBRATION IN OPTICAL DISC DRIVER

(75) Inventors: Chi-mou Chao, Hsin-Chu Hsien (TW); Ying-feng Huang, Chia-Yi Hsien (TW)

Correspondence Address: MADSON & AUSTIN, 15 WEST SOUTH TEMPLE, SUITE 900, SALT LAKE CITY, UT, 84101, US

(73) Assignee: MEDIATEDK Inc., Hsin-Chu (TW)

(21) Appl. No.: 11/693,243

(22) Filed: Mar. 29, 2007

Related U.S. Application Data
(60) Provisional application No. 60/805,684, filed on Jun. 23, 2006.

(51) Int. Cl. G11B 7/00

(52) U.S. Cl. 369/44.35; 369/44.29

(57) ABSTRACT

An apparatus and method for servo balance calibration in an optical disc driver are described. The optical disc driver comprises an OPU for emitting light beam to an optical disc and detecting a reflection light from the optical disc to generate a set of detected signals. The apparatus comprises an amplifying unit, a servo signal generator, a controlling unit, and a balance calibration unit. The amplifying unit receives the detected signals and amplifies the detected signals to be a first set of amplified signals. The servo signal generator having the servo balance gain receives the first set of amplified signals and generates a first servo signal derived from the first set of amplified signals. The controlling unit coupled to the OPU and the amplifying unit controls at last one of the OPU and the amplifying unit to generate a second set of amplified signals. The balance calibration unit coupled to the servo signal generator calculates the first servo signal and a second servo signal derived from the second set of amplified signals to adjust the servo balance gain.

### CROSS REFERENCE TO RELATED APPLICATION

This patent application claims priority from U.S. Provisional Patent Application Ser. No. 60/805,684, which are filed on Jun. 23, 2006 and incorporated herein by reference.

### FIELD OF THE INVENTION

The present invention generally relates to an apparatus and method for servo balance calibration in an optical disc driver, and more particularly, to an apparatus and method for tracking balance calibration in an optical disc driver.

### BACKGROUND OF THE INVENTION

During reading or writing data from/to an optical disc by an optical disc driver, an optical pick-up unit (OPU) in the optical driver should continuously detect the reflection signal from the optical disc to do servo controls so that the OPU could access the optical disc accurately. The OPU comprises a photodiode to detect the reflection light. When laser spot of the reflection light on the photodiode is unbalanced which means the light spot is not in the center of the photodiode or the light spot being detected is unbalanced, the servo control is failed. A servo balance calibration is used to calculate a servo balance gain for correcting the unbalance, and then make the servo control accurately. The tracking balance calibration is most described in the conventional methods. However, the conventional methods are always complicated and ineffective.

### SUMMARY OF THE INVENTION

An apparatus and method for servo balance calibration in an optical disc driver are described in the present application for simply and effectively performing the servo balance calibration. The optical disc driver comprises an OPU for emitting light beam to an optical disc and detecting a reflection light from the optical disc to generate a set of detected signals.

The apparatus according to one aspect of the present invention comprises an amplifying unit, a servo signal generator, a controlling unit, and a balance calibration unit. The amplifying unit receives the detected signals and amplifies the detected signals to be a first set of amplified signals. The servo signal generator having the servo balance gain receives the first set of amplified signals and generates a first servo signal derived from the first set of amplified signals. The controlling unit coupled to the OPU and the amplifying unit controls at last one of the OPU and the amplifying unit to generate a second set of amplified signals. The balance calibration unit coupled to the servo signal generator calculates the first servo signal and a second servo signal derived from the second set of amplified signals to adjust the servo balance gain.

The method according to one aspect of the present invention comprises: amplifying the detected signals to be a first set of amplified signal according to an amplified gain; generating a first servo signal derived from the first set of amplified signals according to the servo balance gain; generating a second set of amplified signals; and calculating the first servo signal and a second servo signal derived from the second set of amplified signal to adjust the servo balance gain.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of an apparatus for adjusting a servo balance calibration in an optical disc driver according to one preferred embodiment of the present invention.

FIG. 2 is a schematic diagram of a photodiode and an amplifying unit shown in FIG. 1 according to one embodiment of the present invention.

FIG. 3A is a waveform diagram of first and second servo signals having different DC levels which are varied with either power levels of the OPU or amplified gains of amplifying unit shown in FIG. 1 according to one embodiment of the present invention.

FIG. 3B is a waveform diagram of aligning the first servo signal and the second servo signal shown in FIG. 3A to have the same direct current (DC) level according to one embodiment of the present invention.

FIG. 3C is a waveform diagram of aligning the second servo signal shown in FIG. 3A to a reference level according to one embodiment of the present invention.

FIG. 4 shows a flow chart of adjusting the servo balance calibration shown in FIG. 1 based on the power levels of the OPU according to a first preferred embodiment of the present invention.

FIG. 5 shows a flow chart of adjusting the servo balance calibration shown in FIG. 1 base on the amplified gains of amplifying unit according to a second preferred embodiment of the present invention.

### DETAILED DESCRIPTION OF THE PREFERRED EMBODIMENTS

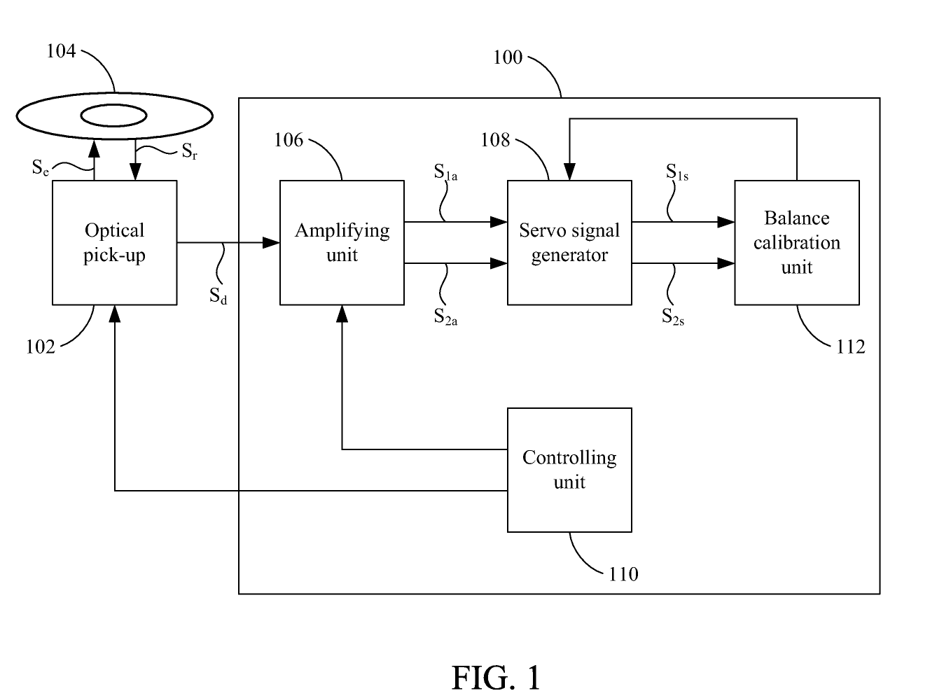

FIG. 1 is a schematic diagram of an apparatus for adjusting a servo balance calibration according to one preferred embodiment of the present invention. The apparatus 100 for servo balance calibration in an optical disc driver is described for simply and effectively performing the servo balance calibration. An optical pick-up unit (OPU) 102 in the optical disc driver emits light beam (Sₑ) to an optical disc 104 and detects a reflection light (Sᵣ) from the optical disc 104 to generate a set of detected signals (S_{d}). In one preferred embodiment of the present invention, the servo balance calibration performed by the apparatus 100 is a tracking balance calibration for the servo control.

The apparatus 100 for servo balance calibration mainly comprises an amplifying unit 106, a servo signal generator 108, a controlling unit 110, and a balance calibration unit 112. The amplifying unit 106 receives the detected signals (S_{d}) and amplifies the detected signals (S_{d}) to be a first set of amplified signals (S₁ₐ). The servo signal generator 108 having the servo balance gain receives the first set of amplified signals (S₁ₐ) and generates a first servo signal (S₁ₛ) derived from the first set of amplified signals (S₁ₐ). The controlling unit 110 is coupled to the OPU 102 and the amplifying unit 106 and controls at last one of the OPU 102 and the amplifying unit 106 to generate a second set of amplified signals (S₂ₐ). The balance calibration unit 112 is coupled to the servo signal generator 108 and calculates the first servo signal (S₁ₛ) and a second servo signal (S₂ₛ) derived from the second set of amplified signals (S₂ₐ) to adjust the servo balance gain of the servo signal generator 108 to perform the servo balance calibration completely.

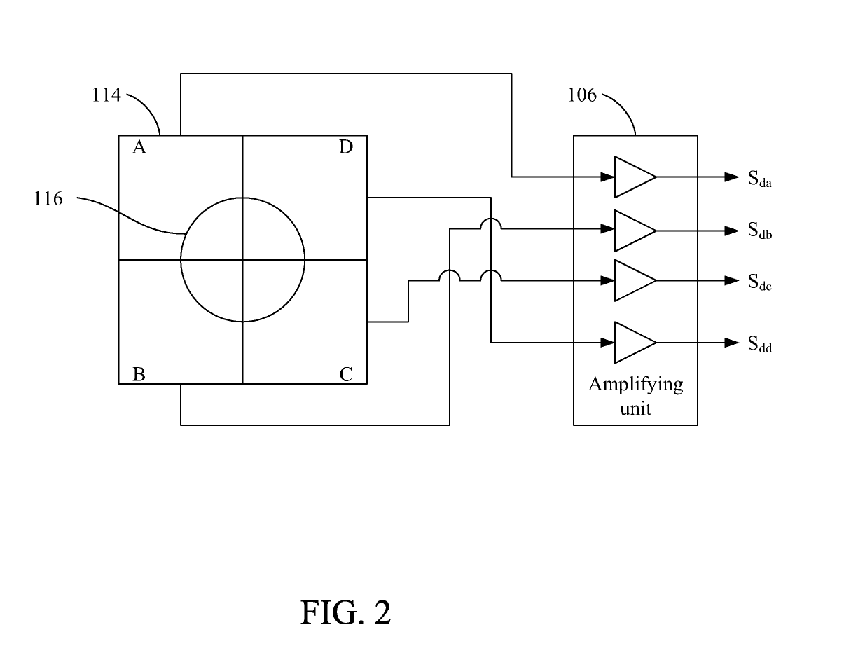

Please refer to FIG. 1 and FIG. 2 which depicts a schematic diagram of a photodiode and an amplifying unit shown in FIG. 1 according to one embodiment of the present invention. The photodiode 114 of the OPU 102 composed of four segments (A, B, C, and D) receives reflection light (Sᵣ) from the optical disc 104 for detecting the reflection light (Sᵣ) to generate the laser spot 116 on the segments. Each of the segments (A, B, C, and D) of the photodiode 114 outputs detected signals (S_{da}, S_{db}, S_{dc}, and S_{dd}) to the amplifying unit 106, respectively. The amplifying unit 106 is used to amplify the detected signals (S_{da}, S_{db}, S_{dc}, and S_{dd}). Preferably, the controlling unit 110 controls the amplifying unit 106 to amplify the detected signals (S_{da}, S_{db}, S_{dc}, and S_{dd}) according to the amplified gain of the amplifying unit 106 to generate the first set of amplified signals (S₁ₐ) and the second set of amplified signals (S₂ₐ). The first set of amplified signals (S₁ₐ) and the second set of amplified signals (S₂ₐ) are transmitted to the servo signal generator 108 to generate the first servo signal (S₁ₛ) and the second servo signal (S₂ₛ), respectively. For an example of tracking balance calibration, the detected signals (S_{da}, S_{db}, S_{dc}, and S_{dd}) from the photodiode 114 are taken to be two sum sets, including (S_{da}+S_{dd}) and (S_{db} and S_{dc}). The servo signal generator 108 calculates the difference between the two sum sets of (S_{da}+S_{dd}) and (S_{db} and S_{dc}).

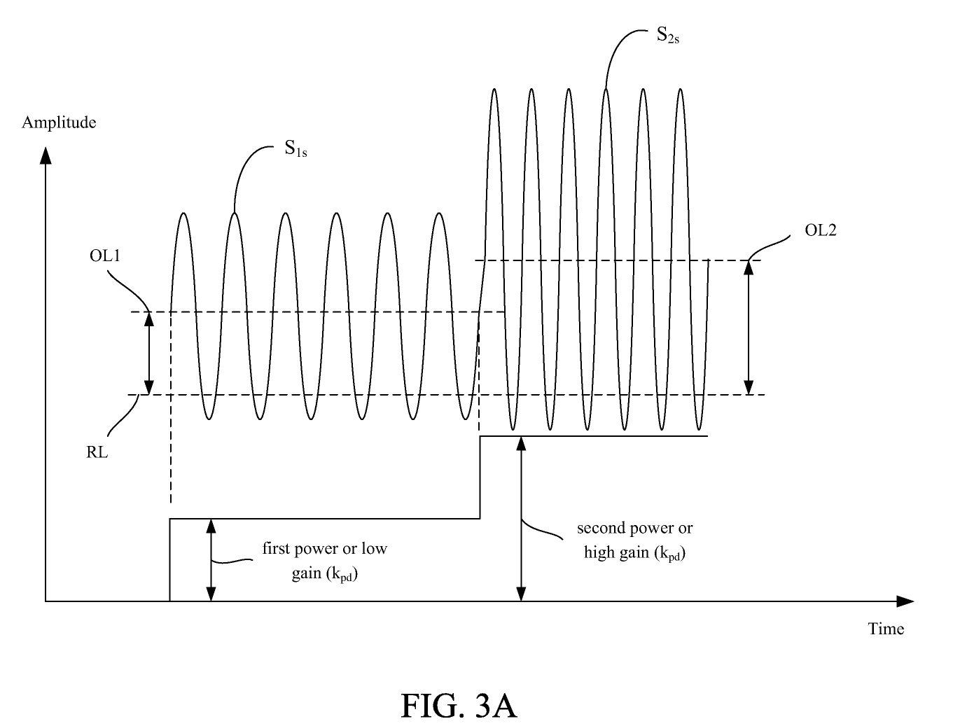

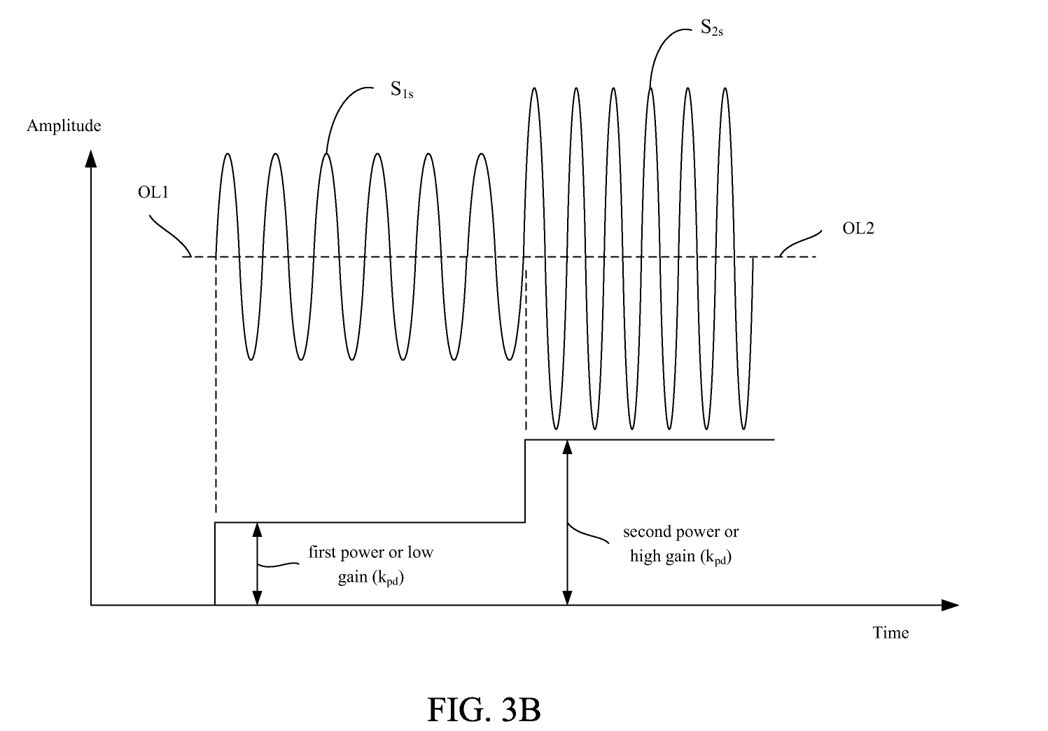

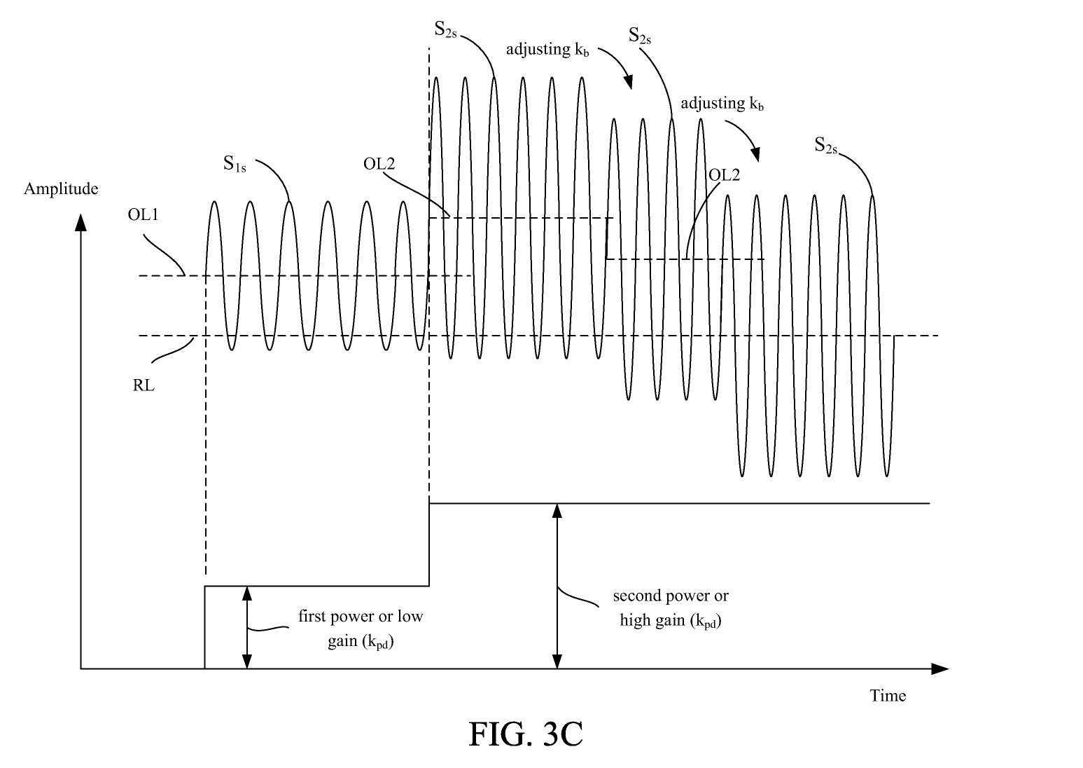

Please refer to FIG. 1, FIG. 2 and FIG. 3A which is a waveform diagram of first and second servo signals having different direct current (DC) levels which are varied with either power levels of the OPU or amplified gains of amplifying unit shown in FIG. 1 according to one embodiment of the present invention. The horizontal axis represents time and the vertical axis represents the amplitudes of the signals in FIG. 3A.

In a first embodiment of the present invention, the controlling unit 110 controls the OPU 102 to emit light with a first power to make the amplifying unit 106 generate the first set of amplified signals (S₁ₐ). The servo signal generator 108 having the servo balance gain (k_{b}) then receives the first set of amplified signals (S₁ₐ) and generates a first servo signal (S₁ₛ) derived from the first set of amplified signals (S₁ₐ). The controlling unit 110 further controls the OPU 102 to emit light with a second power to make the amplifying unit generate the second set of amplified signals (S₂ₐ). The servo signal generator 108 having the servo balance gain (k_{b}) then receives the second set of amplified signals (S₂ₐ) and generates a second servo signal (S₂ₛ). In comparison with a reference level (RL), the first servo signal (S₁ₛ) has a first offset level (OL1) and the second servo signal (S₂ₛ) has a second offset level (OL2). Preferably, the reference level (RL) is defined as the following formula: RL=OL1−(OL2−OL1). It should be noted that arbitrary ratio of the first offset level (OL1) and the second offset level (OL2) is suitable for the present invention. According to the above description, the controlling unit 110 controls the OPU 102 to emit light with different power levels so that the servo signal generator 108 generates servo signals (S₁ₐ, S₂ₛ) with different DC offset levels (OL1, OL2).

In the present invention, the servo signals (S₁ₛ, S₂ₛ) are represented as the following formula:

(S₁ₛ or S₂ₛ)=k_{b}*(S_{da}+S_{dd})−(S_{db}+S_{dc}) (1);

where k_{b} is servo balance gain in the servo signal generator 108, and S_{da}=PR*a, S_{db}=PR*b, S_{dc}=PR*c, and S_{dd}=PR*d.

Therefore, in the first embodiment, formula (1) is represented as follows:

(S₁ₛ or S₂ₛ)=PR[k_{b}(a+d)−(b+c)] (2);

where PR is the laser power, e.g. reading power, of the OPU 102, the value of PR is adjustable, and a, b, c and d are electrical signals associated with the detected signals (S_{da}, S_{db}, S_{dc}, and S_{dd}).

In a second embodiment of the present invention, the amplifying unit 106 amplifies the detected signals from the OPU 102 to generate a first set of amplified signal (S₁ₐ) according to an amplified gain (k_{pd}), such as a low gain. The servo signal generator 108 having the servo balance gain (k_{b}) receives the first set of amplified signals (S₁ₐ) and generates a first servo signal (S₁ₛ) derived from the first set of amplified signals (S₁ₐ). The amplifying unit 106 further amplifies the detected signals from the OPU 102 to generate a second set of amplified signal (S₂ₐ) according to an amplified gain (k_{pd}), such as a high gain. The servo signal generator 108 having the servo balance gain generates a second servo signal (S₂ₛ) derived from the second set of amplified signals (S₂ₐ). In comparison with the reference level (RL), the first servo signal (S₁ₛ) has a first offset level (OL1) and the second servo signal (S₂ₛ) has a second offset level (OL2). Based on the above description, the controlling unit 110 adjusts the amplified gain (k_{pd}) of the amplifying unit 106 to adjust the first set of amplified signals (S₁ₐ) to the second set of amplified signals (S₂ₐ) so that the servo signal generator 108 generates servo signals (S₁ₛ, S₂ₛ) with different DC offset levels (OL1, OL2).

Similarly, in the second embodiment, formula (1) is represented as follows:

(S₁ₛ or S₂ₛ)=k_{pd}[k_{b}(a+d)−(b+c)] (3);

where S_{da}=k_{pd}*a, S_{db}=k_{pd}*b, S_{dc}=k_{pd}*c, and S_{dd}=k_{pd}*d, where amplified gain k_{pd} is adjustable, and a, b, c and d are electrical signals associated with the detected signals (S_{da}, S_{db}, S_{dc}, and S_{dd}).

Please refer to FIG. 1, FIG. 3A and FIG. 3B which is a waveform diagram of aligning the first servo signal and the second servo signal shown in FIG. 3A to have the same direct current (DC) level according to one embodiment of the present invention. The horizontal axis represents time and the vertical axis represents the amplitudes of the signals in FIG. 3B.

The controlling unit 110 controls the OPU 102 to emit light with a first power to make the servo signal generator 108 generate a first servo signal (S₁ₛ), and further controls the OPU 102 to emit light with a second power to make the servo signal generator 108 generate a second servo signal (S₂ₛ). In addition, the controlling unit 110 controls the amplifying unit 106 to amplify the detected signals for generating a first set of amplified signal (S₁ₐ) according to an amplified gain (k_{pd}), such as a low gain. The servo signal generator 108 generates a first servo signal (S₁ₛ) derived from the first set of amplified signals (S₁ₐ). The controlling unit 110 controls the amplifying unit 106 to amplify the detected signals for generating a second set of amplified signal (S₂ₐ) according to an amplified gain (k_{pd}), such as a high gain. The servo signal generator 108 generates a second servo signal (S₂ₛ) derived from the second set of amplified signals (S₂ₐ).

The balance calibration unit 112 compares the first offset level (OL1) with the second offset level (OL2) to determine that the first offset level (OL1) is the same as the second offset level (OL2) or not. When the first offset level (OL1) is different from the second offset level (OL2) or the level difference between the first offset level (OL1) and the second offset level (OL2) exceeds a predetermined offset threshold, the balance calibration unit 112 adjusts the servo balance gain (k_{b}) of the servo signal generator 108 continuously by aligning the first servo signal (S₁ₛ) and the second servo signal (S₂ₛ) until the first offset level (OL1) is same as the second offset level (OL2). In other words, the first servo signal (S₁ₛ) is aligned to the second servo signal (S₂ₛ) at the same central level.

Please refer to FIG. 1, FIG. 3A and FIG. 3C which is a waveform diagram of aligning the second servo signal shown in FIG. 3A to a reference level according to one embodiment of the present invention. Similar to FIG. 3B, the servo signal generator 108 generate a first servo signal (S₁ₛ) and a second servo signal (S₂ₛ) according to a first power and a second power, respectively. Alternatively, according to a low gain, the servo signal generator 108 generates a first servo signal (S₁ₛ), and according to a high gain, the servo signal generator 108 generates a second servo signal (S₂ₛ).

The balance calibration unit 112 compares the first offset level (OL1) with the reference level (RL) to determine that the second offset level (OL2) is the same as the reference level (RL) or not. When the first offset level (OL1) is different from the reference level (RL) or the level difference between the first offset level (OL1) and the reference level (RL) exceeds a predetermined offset threshold, the balance calibration unit 112 continuously adjusts the servo balance gain (k_{b}) of the servo signal generator 108 by aligning the second servo signal (S₂ₛ) until the second offset level (OL2) is same as the reference level (RL). Preferably, the first offset level (OL1) and the second offset level (OL2) have a ratio 1/2 associated with the laser power levels or the amplified gain (k_{pd}) and the reference level (RL) is defined as the following formula: RL=OL1−(OL2−OL1). It should be noted that arbitrary ratio of the first offset level (OL1) and the second offset level (OL2) is suitable for the present invention.

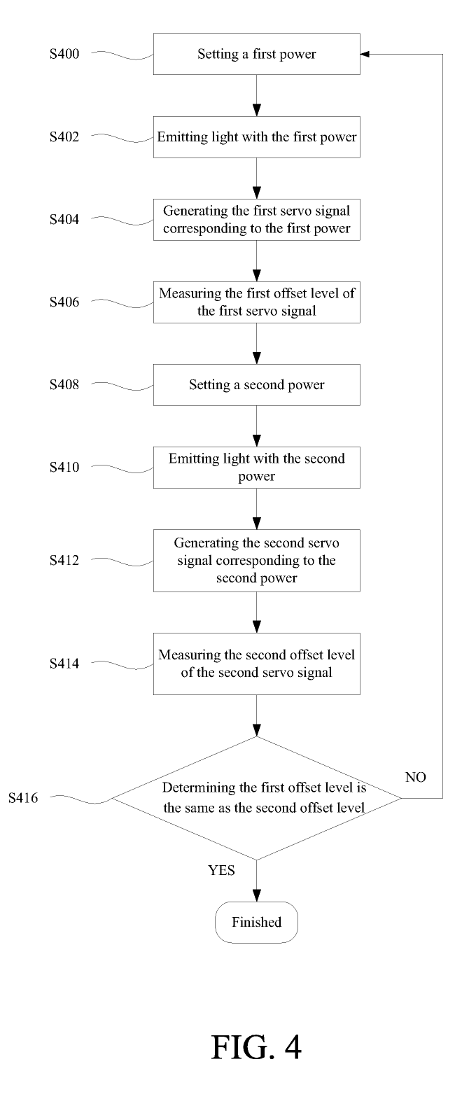

Please refer to FIG. 1 and FIG. 4 which depicts a flow chart of adjusting the servo balance calibration shown in FIG. 1 based on the power levels of the OPU according to a first preferred embodiment of the present invention. The steps of performing servo balance calibration are described as follows:

In step S400, the controlling unit 110 sets the laser power level of the OPU 102 as the first power. In step S402, the OPU 102 emits light with the first power. In step S404, the servo signal generator 108 having the servo balance gain (k_{b}) generates the first servo signal (S₁ₛ) corresponding to the first power. In step S406, the controlling unit 110 controls the servo signal generator 108 to measure the first offset level of the first servo signal (S₁ₛ).

In step S408, the controlling unit 110 sets the laser power level of the OPU 102 as the second power. In step S410, the OPU 102 emits light with the second power. In step S412, the servo signal generator 108 having the servo balance gain (k_{b}) generates the second servo signal (S₂ₛ) corresponding to the second power. In step S414, the controlling unit 110 controls the servo signal generator 108 to measure the second offset level of the second servo signal (S₂ₛ).

In step S416, the balance calibration unit 112 compares the first offset level with the second offset level to determine that the first offset level is the same as the second offset level or not. If the decision result is “YES”, the servo balance calibration is finished to generate the desired servo balance gain (k_{b}). If the decision result is “NO”, the balance calibration unit 112 adjusts the servo balance gain (k_{b}) of the servo signal generator 108 and return to step S400 for adjusting the servo balance gain continuously until the first offset level is the same as the second offset level for completing the servo balance calibration.

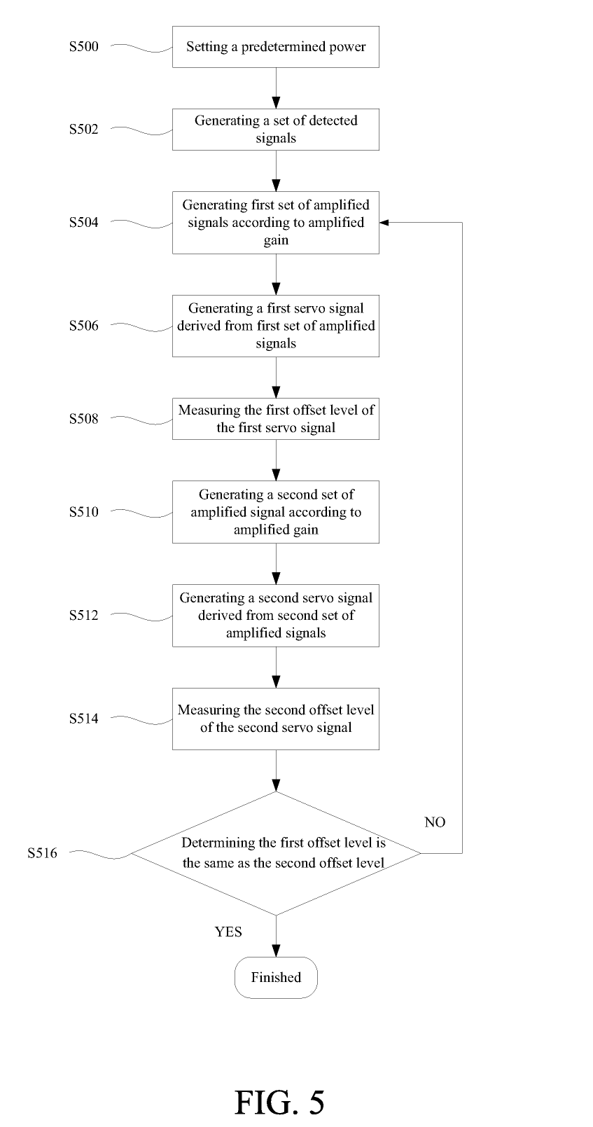

Please refer to FIG. 1 and FIG. 5 shows a flow chart of adjusting the servo balance calibration shown in FIG. 1 base on the amplified gains of amplifying unit according to a second preferred embodiment of the present invention. The steps of performing servo balance calibration are described as follows:

In step S500, the controlling unit 110 sets the laser power level of the OPU 102 as the predetermined power. In step S502, the OPU 102 generates a set of detected signals corresponding to the predetermined power.

In step S504, the amplifying unit 106 amplifies the detected signals from the OPU 102 to generate a first set of amplified signals according to an amplified gain, such as a low gain. In step S506, the servo signal generator 108 having the servo balance gain (k_{b}) generates a first servo signal (S₁ₛ) derived from the first set of amplified signals. In step S508, the controlling unit 110 measures the first offset level of the first servo signal (S₁ₛ) corresponding to the first set of amplified signals.

In step S510, the amplifying unit 106 amplifies the detected signals from the OPU 102 to generate a second set of amplified signal according to an amplified gain, such as a high gain. In step S512, the servo signal generator 108 having the servo balance gain (k_{b}) generates a second servo signal (S₂ₛ) derived from the second set of amplified signals. In step S514, the controlling unit 110 measures the second offset level of the second servo signal (S₂ₛ) corresponding to the second set of amplified signals.

In step S516, the balance calibration unit 112 compares the first offset level with the second offset level to determine that the first offset level is the same as the second offset level or not. If the decision result is “YES”, the servo balance calibration is finished to generate the desired servo balance gain (k_{b}). If the decision result is “NO”, the balance calibration unit 112 adjusts the servo balance gain (k_{b}) of the servo signal generator 108 and return to step S504 for adjusting the servo balance gain (k_{b}) continuously until the first offset level is the same as the second offset level for completing the servo balance calibration.

The features of the present invention mainly include: (a) simply performing servo balance calibration in an optical disc driver; and (b) effectively performing the servo balance calibration by adjusting power levels and amplified gain corresponding to the servo signals.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. An apparatus for adjusting a servo balance gain in an optical disc driver, said optical disc driver comprising an optical pick-up unit (OPU) for emitting light beam to an optical disc and detecting a reflection light from the optical disc to generate a set of detected signals, the apparatus comprising:
an amplifying unit for receiving the detected signals and amplifying the detected signals to be a first set of amplified signals according to an amplified gain;
a servo signal generator having the servo balance gain for receiving the first set of amplified signals and generating a first servo signal derived from the first set of amplified signals;
a controlling unit coupled to the OPU and the amplifying unit for controlling at last one of the OPU and the amplifying unit to generate a second set of amplified signals; and
a balance calibration unit coupled to the servo signal generator for calculating the first servo signal and a second servo signal derived from the second set of amplified signals to adjust the servo balance gain of the servo signal generator to perform a servo balance calibration.

2. The apparatus of claim 1, wherein the controlling unit adjusts the amplified gain to adjust the first set of amplified signals to the second set of amplified signals.

3. The apparatus of claim 1, wherein the controlling unit controls the OPU to emit light with a first power to make the amplifying unit generate the first set of amplified signals, and the controlling unit controls the OPU to emit light with a second power to make the amplifying unit generate the second set of amplified signals.

4. The apparatus of claim 1, wherein the balance calibration unit adjusts the servo balance gain of the servo signal generator for aligning the first servo signal and the second servo signal to have the same direct current (DC) level.

5. The apparatus of claim 1, wherein the servo balance calibration is a tracking balance calibration.

6. A method for adjusting a servo balance gain in an optical disc drive, said optical disc driver comprising an optical pick-up unit (OPU) for emitting light beam to an optical disc and detecting a reflection light from the optical disc to generate a set of detected signals, the method comprising the steps of:
amplifying the detected signals to be a first set of amplified signal according to an amplified gain;
generating a first servo signal derived from the first set of amplified signals according to the servo balance gain;
generating a second set of amplified signals; and
calculating the first servo signal and a second servo signal derived from the second set of amplified signal to adjust the servo balance gain to perform a servo balance calibration.

7. The method of claim 6, wherein the step of generating the second set of amplified signal is a step of adjusting the amplifying gain to adjust the first set of amplifying signals to the second set of amplifying signals.

8. The method of claim 6, wherein the OPU emits light with a first power to generate the first set of amplifying signals, and the step of generating the second set of amplified signal is a step of controlling the OPU to emit light with a second power to generate the second set of amplifying signals.

9. The method of claim 6, wherein the servo balance gain is adjusted for aligning the first servo signal and the second servo signal to have the same DC level.

10. The method of claim 6, wherein the servo balance calibration is the tracking balance calibration.
